(19) United States
(12) Patent Application Publication
(10) Pub. No.: US 2020/0177043 A1
(43) Pub. Date: Jun. 4, 2020

(54) FUEL-COOLED BRUSHLESS MACHINE SYSTEM FOR GAS TURBINE ENGINE

(71) Applicant: PRATT & WHITNEY CANADA CORP., Longueuil (CA)

(72) Inventor: Issam AL-KHAIRY, Montreal (CA)

(21) Appl. No.: 16/204,327

(22) Filed: Nov. 29, 2018

(51) Int. Cl. H02K 3/24; F01D 25/12; F02C 7/22; F02C 7/275; F01D 15/10

(52) U.S. Cl. CPC H02K 3/24; F01D 25/12; F02K 3/06; F02C 7/275; F01D 15/10; F02C 7/22

(57) ABSTRACT

A brushless machine system and a method for operating same, the system comprising an electric machine assembly having a permanent magnet rotor and a stator with stator windings, a gas turbine engine fuel metering unit having a fuel pump for pumping liquid gas turbine engine fuel, and at least one passage extending between the electric machine assembly and the fuel metering unit, the cooling passage having a portion in contact with the stator such that liquid fuel passing therethrough cools the stator windings.

### TECHNICAL FIELD

The present disclosure relates generally to brushless machines, and more particularly to fuel-cooling same.

### BACKGROUND OF THE ART

In common type brushless machines, rotation is achieved by controlling the magnetic fields generated by the coils on the rotor while the magnetic field generated by the permanent stationary magnets remains fixed.

However, brushless machines have a higher initial cost than brushed machines. Some of the factors that affect the overall costs are assembly size, weight, duty cycle, and power output.

There is a need for improvement.

### SUMMARY

In accordance with a broad aspect, there is provided a brushless machine system for a gas turbine engine. The system comprises an electric machine assembly having a permanent magnet rotor and a stator with stator windings, a gas turbine engine fuel metering unit having a fuel pump for pumping liquid gas turbine engine fuel, and at least one passage extending between the electric machine assembly and the fuel metering unit, the cooling passage having a portion in contact with the stator such that liquid fuel passing therethrough cools the stator windings.

In accordance with another broad aspect, there is provided a method for operating a brushless machine system for a gas turbine engine. The method comprises converting motive power into electrical power using an electric machine assembly having a permanent magnet rotor and a stator with stator windings, pumping liquid fuel through a gas turbine engine fuel metering unit having a fuel pump, and cooling the stator windings with the liquid fuel by flowing the liquid fuel through at least one passage extending between the machine assembly and the fuel metering unit, the at least one cooling passage having a portion in contact with the stator.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a schematic cross-sectional view of a gas turbine engine, in accordance with an illustrative embodiment;

FIG. 2 is a perspective view of a fuel-cooled brushless machine system, in accordance with an illustrative embodiment;

FIG. 3 is a cross-sectional view of the system of FIG. 2 along lines A-A, in accordance with an illustrative embodiment;

FIG. 4 is a cross-sectional view of the system of FIG. 2 along lines A-A, in accordance with an illustrative embodiment;

FIG. 5 is a cross-sectional view of the system of FIG. 2 along lines A-A, in accordance with an illustrative embodiment;

FIG. 6 is a cross-sectional view of the system of FIG. 2 along lines A-A, in accordance with an illustrative embodiment;

FIG. 7 is a cross-sectional view of the system of FIG. 2 along lines A-A, in accordance with an illustrative embodiment;

FIG. 8 is a cross-sectional view of the system of FIG. 2 along lines A-A, in accordance with an illustrative embodiment; and

FIGS. 9A-9D are cross-sectional views of the system of FIG. 2 along lines B-B, in accordance with illustrative embodiments.

It will be noted that throughout the appended drawings, like features are identified by like reference numerals.

### DETAILED DESCRIPTION

There is described herein a fuel-cooled brushless machine system. An electric machine assembly is combined with a fuel metering unit (FMU) and liquid fuel from the FMU is used to cool the stator windings of the electric machine. The savings provided by cooling the stator windings can be used for one or more of reducing the size of the machine, increasing the mechanical output duty cycle, increasing electrical generation capacity, improving system efficiency, and lowering the weight of the machine.

The fuel-cooled brushless machine system may be used in combination with any type of gas turbine engine, such as but not limited to a turbofan engine, a turboprop engine, a turboshaft engine, and the like. The engine may be used for various applications, such as aircraft, ships, trains, tanks, cars, buses, motorcycles, and the like. Any type of liquid fuel suitable for gas turbine engines may be used, namely aviation turbine fuel (ATF).

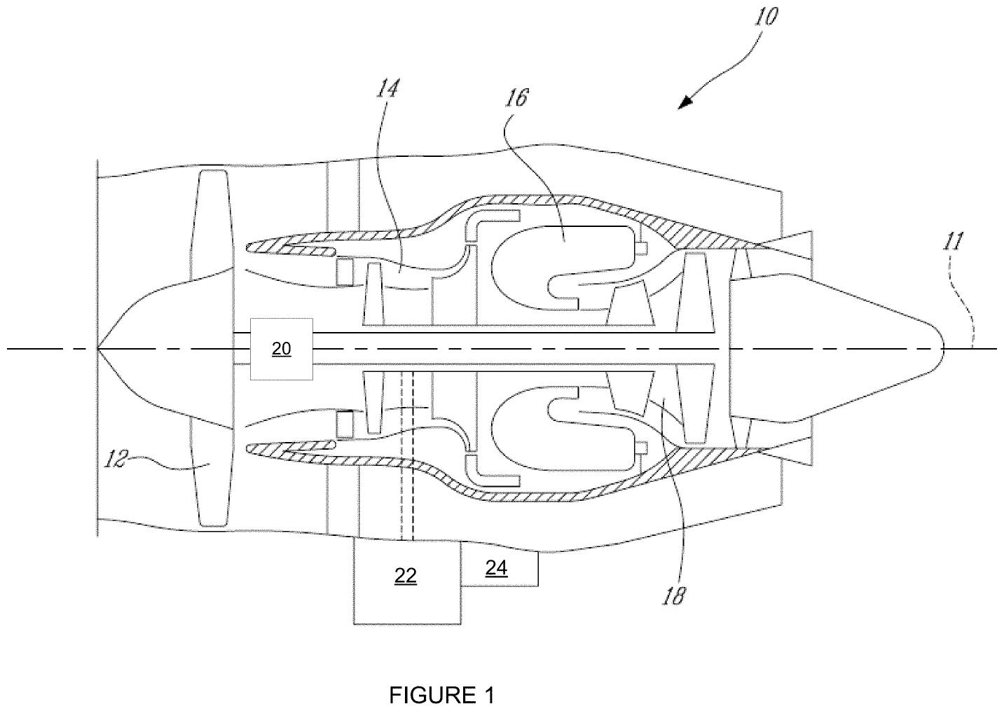

FIG. 1 illustrates an example of a gas turbine engine 10 of a type preferably provided for use in subsonic flight. The engine 10 generally comprises in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. A reduction gearbox (RGB) 20 is used, in some instances, to couple the compressor-turbine assembly to the fan 12. An accessory gearbox (AGB) 22 may be used to couple one or more accessories 24 to the engine 10.

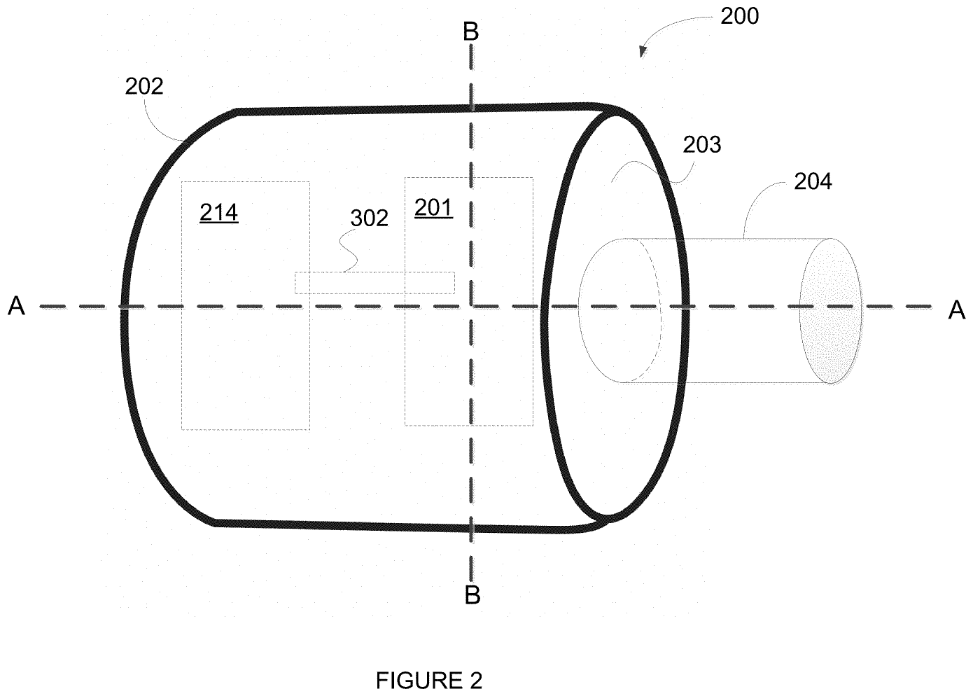

Referring now to FIG. 2, there is illustrated an example embodiment for a fuel-cooled brushless machine system 200. The system 200 combines a fuel metering unit (FMU) 214 and an electric machine assembly 201 under a same housing 202. The electric machine assembly 201 converts motive power into electrical power. At least one cooling passage 302 extends between the electric machine assembly 201 and the FMU 214 for flowing fuel therethrough. The fuel is used to cool the stator windings of the motor assembly 201.

In some embodiments, the electric machine assembly 201 is a starter-generator. Alternatively, the electric machine assembly 201 may be any type of electrical generator or motor, such as an alternator, an inductor motor, or any other AC or DC brushless machine.

In some embodiments, the electric machine assembly 201 and FMU 214 are both powered by a drive shaft 204 that extends from the housing 202. The system 200 may be coupled to an engine, such as gas turbine engine 10, by connecting the shaft 204 to the RGB 20 or the AGB 22 of the engine 10. The single shaft 204 allows a single gear set to be used to couple the system 200 to the engine 10.

Although illustrated as cylindrical, the system 200 may be of various shapes, such as but not limited to elliptical, rectangular, and non-geometrical shapes. In some embodiments, the housing 202 covers less than the entire system 200. For example, the surface 203 from which the shaft 204 extends may remain open. Other embodiments for the housing 202 may also apply.

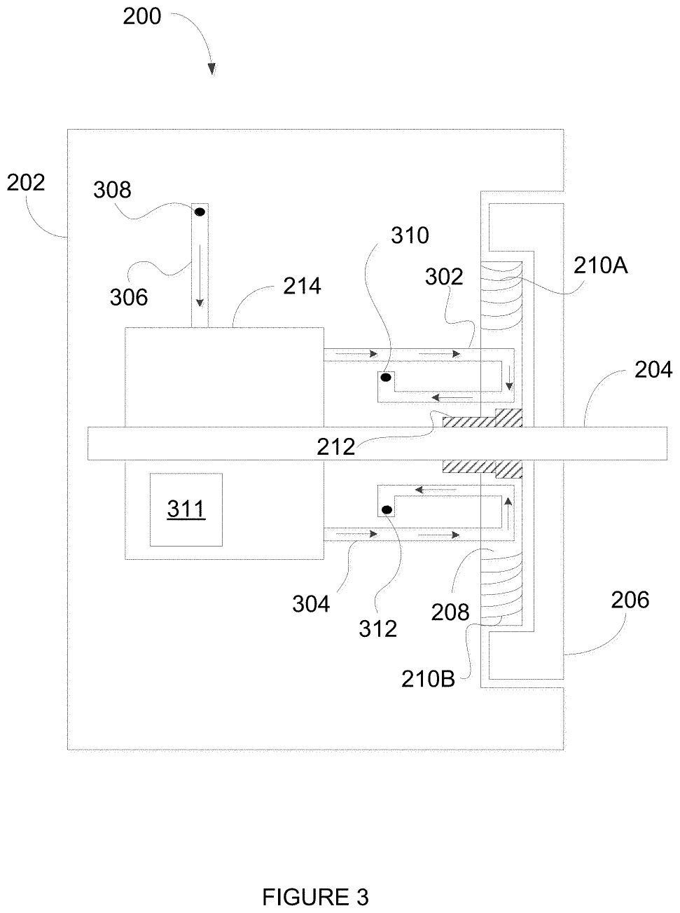

FIG. 3 is an example cross-section of the system 200 along lines A-A of FIG. 2. In this example, the system 200 comprises a permanent magnet rotor 206 and a stator 208. The stator 208 has one or more windings 210a, 210b that are configured to conduct an output current induced in the windings 210a, 210b by rotation of the rotor 206. The rotor 206, stator 208, and windings 210a, 210b are part of the motor assembly 201. The shaft 204 extends through the motor assembly 201. A bearing 212 allows the shaft to move inside the housing 202.

The shaft 204 is also connected to the FMU 214. In some embodiments, the FMU 214 pumps, meters, and filters fuel received from a fuel tank and supplies the gas turbine engine 10 with fuel for combustion. Control of the FMU 214 may be hydromechanical, hydromechanical/electronic, or Full Authority Digital Engine Control (FADEC). The FMU 214 is composed of at least a fuel pump 311 for pumping fuel. In some embodiments, the FMU 214 is also composed of one or more other components, such as filters, sensors, valves, controllers and the like. For example, the FMU 214 may comprise a mechanical speed governor, a solenoid, a fuel bypass valve, a servo pressure regulator, an enrichment solenoid, a servo metering valve assembly, a fuel shutoff valve, a metering head sensor, and a pressurizing valve. The FMU 214 may dynamically alter the position of various valves to either increase or decrease the flow of fuel to the engine 10 as a function of demand. In some embodiments, one or more of the filters, sensors, pressure valves, controllers, etc., are external to the FMU 214 and to the system 200.

The fuel pump 311 is powered by the shaft 204. The fuel pump 311 is configured to receive fuel at a first pressure, i.e. low pressure, and increase the pressure to a second pressure, i.e. high pressure. Low pressure fuel is received from a fuel tank, external to the system 200, and provided to the fuel pump 311 in the FMU 214. High pressure fuel is then pumped out of the FMU 214 and provided to an engine, such as gas turbine engine 10. Fuel is received, from the fuel tank or an intermediary component, at a fuel inlet 308, and output from the system 200 at a fuel outlet 310.

One or more cooling passages 302, 304 are provided to cool the windings 210a, 210b of the stator 208. The cooling passages 302, 304 have at least a portion that is in contact with the stator 208. For example, the passages 302, 304 may correspond to tubing that runs at least in part over the stator 208 such that the cold fuel absorbs some of the heat generated by the windings 210a, 210b. In another embodiment, the passages 302, 204 are channels or grooves that run at least in part through the stator 208. It will be understood that the passages 302, 304 may be embodied through various configurations, several of which are illustrated herein. The arrows in the passages 302, 304 indicate the direction of fuel flow.

In the example of FIG. 3, a first cooling passage 302 runs from the FMU 214 to a first fuel outlet 310. Fuel flows from the FMU 214 through the first cooling passage 302, contacts the stator 208 to cool the windings 210a and exits the system 200 through the fuel outlet 310. A second cooling passage 304 runs from the FMU 214 to a second fuel outlet 312. Fuel flows from the FMU 214 through the second cooling passage 304, contacts a different portion of the stator 208 to cool the windings 210b and exits the system 200 through the second fuel outlet 312. In this example, fuel is initially received at fuel inlet 308 and flown into the FMU 214 through a passage 306. The fuel pump 311 increases the fuel pressure from low to high before flowing the fuel through the first and second cooling passages 302, 204. The windings 210a, 210b are thus cooled with high pressure fuel.

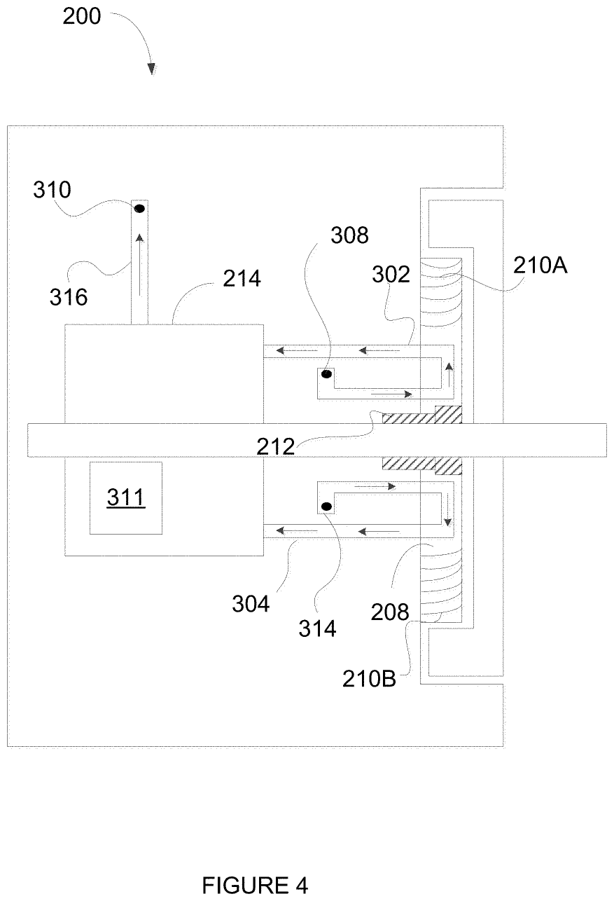

FIG. 4 illustrates another example embodiment for the system 200. Fuel is received at fuel inlets 308, 314 and flown directly in the cooling passages 302, 304 respectively, where it contacts the stator 208 and cools the windings 210a, 210b, respectively. The fuel is then directed towards the FMU 214, where the fuel pressure gets increased by the fuel pump 311 before the fuel is flown out of the FMU 214 through passage 316 towards fuel outlet 310. The fuel that cools the windings 210a, 210b is thus low pressure fuel. While the embodiments of FIGS. 3 and 4 illustrate two cooling passages 302, 304, more than two cooling passages may be provided.

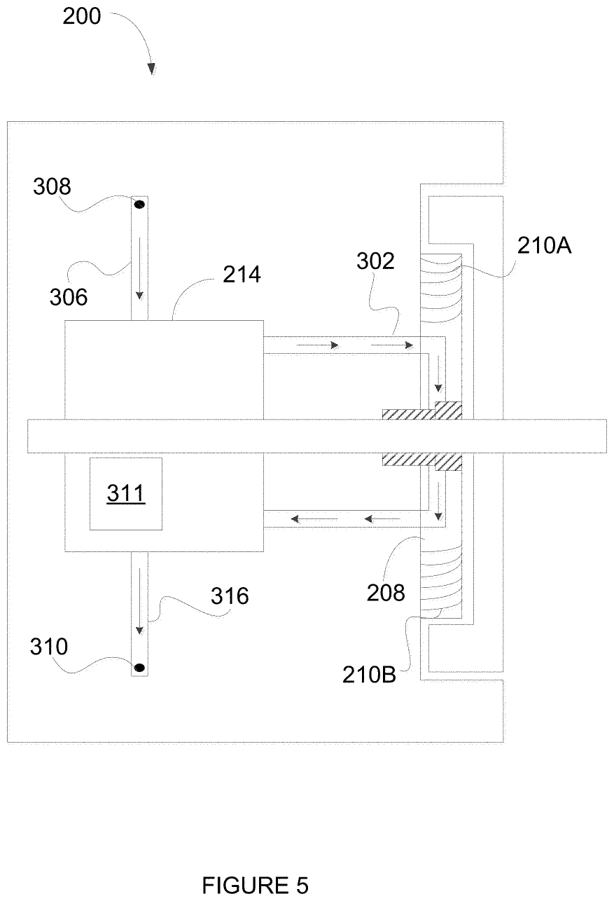

In some embodiments, each winding 210a, 210b is provided with a cooling passage 302, 304 for cooling. Alternatively, a cooling passage 302 is provided to cool more than one winding 210a, 210b, as illustrated in the embodiment of FIG. 5. In this example, cooling passage 302 is provided between the FMU 214 and the stator 208. Fuel is initially received at fuel inlet 308 and flown through passage 306 towards the FMU 214. Fuel is flown from the FMU 214 into the cooling passage 302 towards the stator 208 to cool the windings 210a, 210b before returning to the FMU 214. The fuel pump 311 increases the fuel pressure and high pressure fuel is flown towards fuel outlet 310 via passage 316. In the embodiment of FIG. 5, the fuel used to cool the windings 210a, 210b may be low pressure fuel or high pressure fuel. It will be understood that a cooling passage 302 may be used to cool more than two windings 210a, 210b.

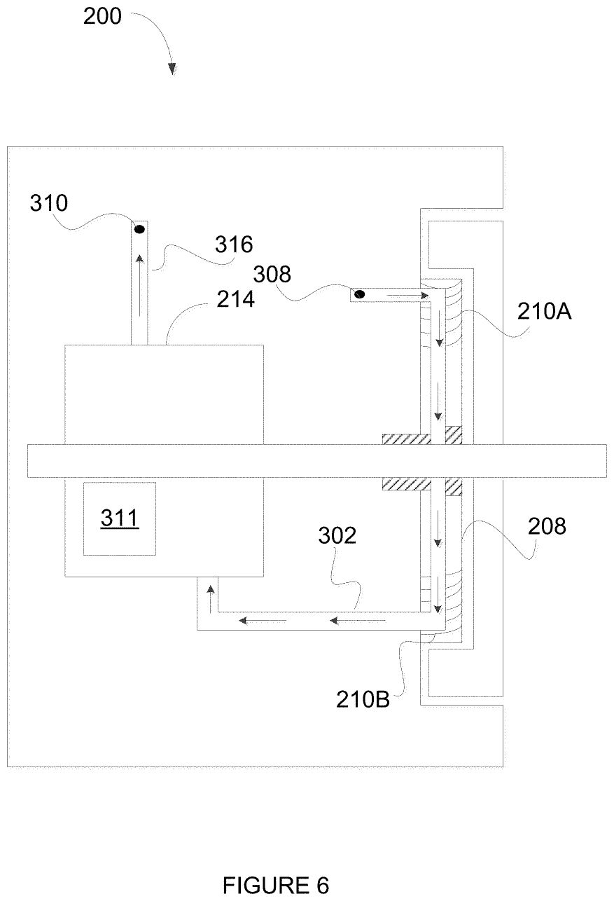

FIG. 6 illustrates yet another embodiment for the system 200. Fuel is received via fuel inlet 308 and flown through cooling passage 302 at low pressure. Cooling passage 302 is used to cool both windings 210a, 210b. Cooling passage 302 redirects the fuel towards the FMU 214 after coming into contact with the stator 208. The fuel pump 311 increases the fuel pressure and high pressure fuel is delivered to the fuel outlet 310 via passage 316.

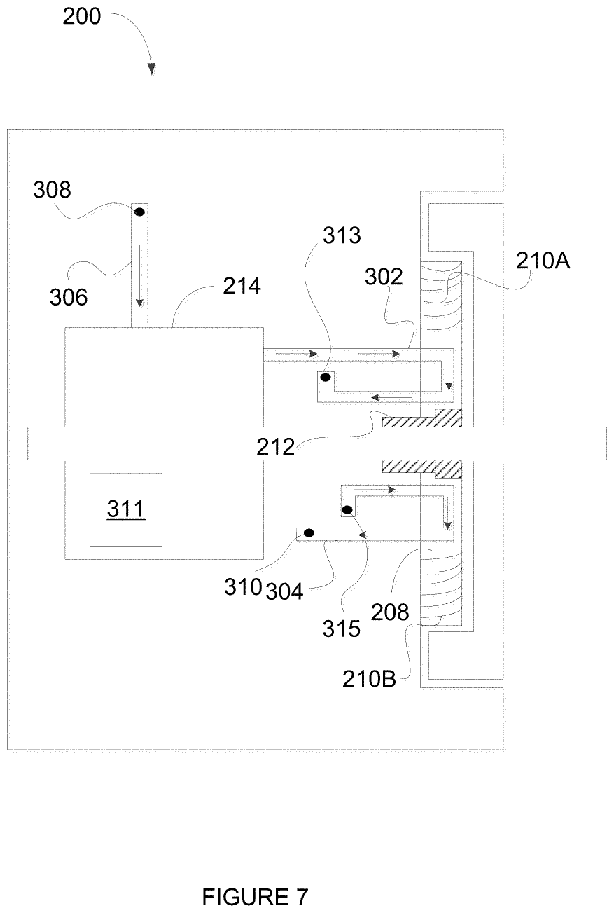

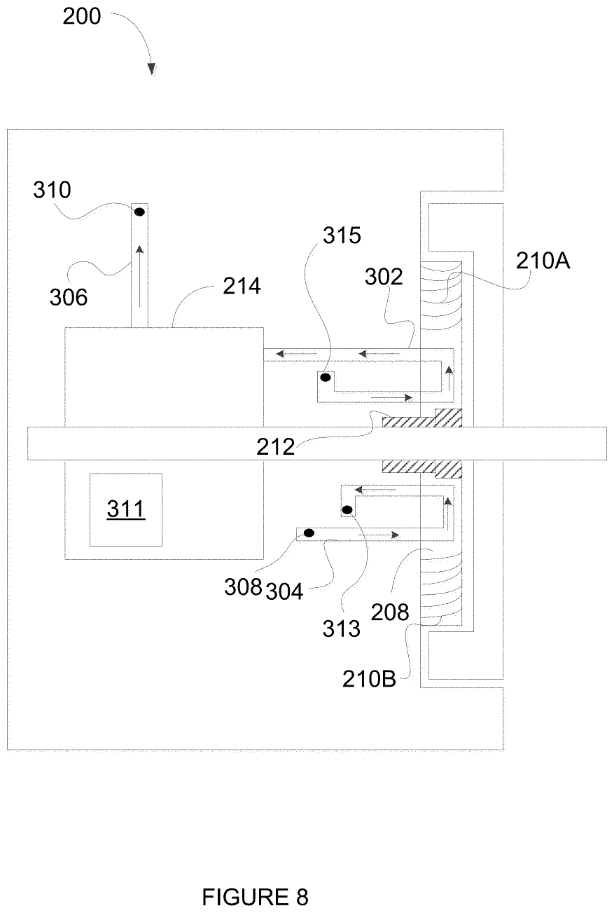

In some embodiments, two or more cooling passages 302, 304 are connected together so that fuel will flow sequentially therethrough. An example is illustrated in FIG. 7. Fuel is initially received at fuel inlet 308 and flown towards the FMU 214 through passage 306. Fuel pump 311 raises the pressure of the fuel and high pressure fuel is flown through cooling passage 302 to cool windings 210a. Passage outlet 313 is connected to passage inlet 315 to allow fuel to flow from the first cooling passage 302 to the second cooling passage 304. The fuel flowing through the second cooling passage 304 cools windings 210b and exits the system 200 via fuel outlet 310. The direction of flow may also be reversed, as illustrated in the example of FIG. 8. Fuel is received at fuel inlet 308 and flown through cooling passage 304 to cool windings 210b. The fuel, which is at low pressure, is then sent to cooling passage 302 via passage outlet 313 and passage inlet 315. The fuel flows through cooling passage 302 to cool windings 210a before being sent to the FMU 214. The fuel pump 311 increases the fuel pressure and high pressure fuel is output at fuel outlet 310 via passage 306. More than two cooling passages 302, 304 may be connected via passage outlets 313 and passage inlets 315 to flow fuel sequentially therethrough.

It will be understood that many other configurations may be used for cooling passages 302, 304, as well as for passages 306, 316. One or more fuel inlet and outlet 308, 310 may be positioned as desired to provide a flow of fuel that will cool the windings 210a, 210b and pass through fuel pump 311 to increase fuel pressure for delivery to engine 10. One or more passage inlets and outlets 313, 315 may be used to direct the fuel from one cooling passage 302 to another 304, and vice versa.

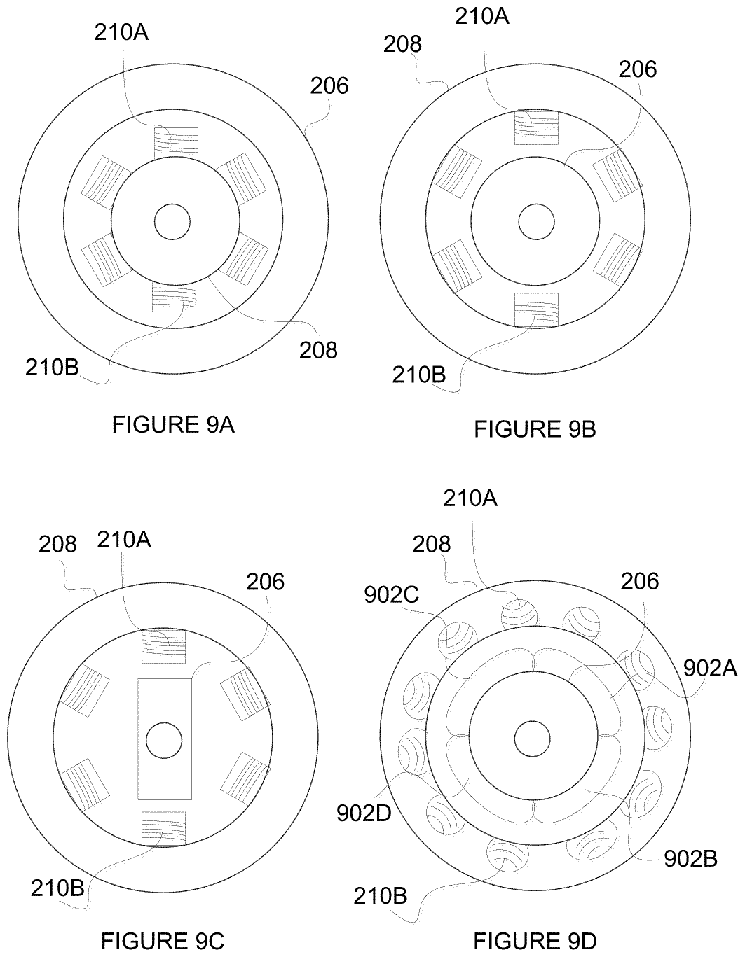

FIGS. 3 to 8 illustrate the electric machine assembly 201 of system 200 as an outer rotor design. An example is illustrated in FIG. 9A, which is a cross-sectional view of the system 200 of FIG. 2 taken along lines B-B. The windings 210a, 210b are located in the core of the electric machine assembly 201 on the stator 208. It should be understood that the electric machine assembly 201 may also be provided as an inner rotor design, as illustrated in FIG. 9B. The stator windings 210a, 210b surround the rotor 206 and are affixed to the outer stator 208. Although illustrated as round, the rotor 206 may also be of a different shape, such as the rectangular rotor 206 illustrated in FIG. 9C. In some embodiments, the rotor 206 is itself made of a material that is a permanent magnet. In other embodiments, one or more permanent magnet 902a, 902b, 902c, 902d is affixed to the rotor, as illustrated in the example of FIG. 9D. It should be understood that various configurations may be used for the electric machine assembly 201, with regards to at least the number of windings 210a, 210b, the position of the windings 210a, 210b, the arrangement of the windings 210a, 210b, the position and arrangement of the rotor 206 and stator 208, the position and arrangement of one or more permanent magnet 902a-902d, and any other design detail regarding the electric machine assembly 201.

The system 200 as described herein is operated by inducing an output current in at least one winding 210a, 210b of the stator 208 by rotation of the permanent magnet rotor 206. The fuel pump 311 of the FMU 214 may be powered with the shaft 204 that is mounted to the rotor 206. Fuel is received at a first pressure at one or more fuel inlet 308, 314 and output at a second pressure at one or more fuel outlet 310, 312. The windings 210a, 210b are cooled with the fuel by flowing the fuel in one or more cooling passage 302, 304 having a portion in contact with the stator 208. Fuel is directed to the FMU 214 to increase the pressure from the first pressure (low pressure) to the second pressure (high pressure) before being output at the outlets 310, 314.

In some embodiments, one or more of the fuel cooling passages 302, 304 flows the fuel through the stator 208. Alternatively, a tubing external to the stator 208 is used to contact the stator 208 with the fuel.

The direction of fuel flow between the FMU 214 and the electric machine assembly 201 through the one or more cooling passages 302, 304 and the arrangement of the one or more fuel inlets 308, 314 and fuel outlets 310, 312 may vary. For example, fuel may be received at a fuel inlet 308, flown through a cooling passage 302 in contact with the stator 208 to cool windings 210a, and directed towards the FMU 214. Fuel pressure is raised by the fuel pump 311 and then the fuel is flown through another cooling passage 304 in contact with the stator 208 to cool windings 210b, after which the fuel is output via fuel outlet 310. In this example, there is no need for passage 306, and coil windings 210a are cooled with low pressure fuel while coil windings 210b are cooled with high pressure fuel. Other embodiments also apply, as described herein with reference to FIGS. 3 to 8.

The electric machine assembly 201 as described herein may be under-designed compared to the specifications needed for a particular application. In other words, the electric machine assembly 201 may be designed to over-heat when running at full capacity, and the fuel running through the one or more cooling passages is used to prevent the over-heating. Indeed, coil winding temperature increase is one of the main factors that govern assembly size, weight, duty cycle, and power output for a brushless motor. Under-designing may therefore result in gains in terms of weight and/or costs of the system 200, and power density and efficiency can be maximized by using the cooling passages to cool the windings. Under-designing of the electric machine assembly 201 may refer to the number of windings used, the wire gauge, the overall size of the electric machine assembly 201, and any other design characteristic that affects performance of the system 200.

The common shaft 204 used by the electric machine assembly 201 and the FMU 214 provides savings in terms of gearings used to couple the system 200 to the engine 10. A single set of gears may be used for the system 200 instead of the traditional two sets of gears, where one gear set couples a machine to an engine and another gear set couples an FMU to the engine. Additional savings of assembly time and engine installation time, wire harness complexity reduction, and gearbox size may also be obtained.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A brushless machine system for a gas turbine engine, the system comprising:
an electric machine assembly having a permanent magnet rotor and a stator with stator windings;
a gas turbine engine fuel metering unit having a fuel pump for pumping liquid gas turbine engine fuel; and
at least one passage extending between the electric machine assembly and the fuel metering unit, the cooling passage having a portion in contact with the stator such that liquid fuel passing therethrough cools the stator windings.

2. The system of claim 1, wherein the at least one passage flows through the stator.

3. The system of claim 1, wherein the at least one passage directs the liquid fuel received at a fuel inlet towards the stator and then sends the liquid fuel to the fuel metering unit.

4. The system of claim 1, wherein the at least one passage directs the liquid fuel from the fuel metering unit to the stator.

5. The system of claim 4, wherein the at least one passage returns the liquid fuel to the fuel metering unit after cooling the stator.

6. The system of claim 4, wherein the at least one passage sends the liquid fuel to a fuel outlet after cooling the stator.

7. The system of claim 1, wherein the electric machine assembly is a starter-generator.

8. The system of claim 1, further comprising a housing covering the fuel metering unit and at least part of the machine assembly.

9. The system of claim 1, wherein the electric machine assembly comprises a shaft mounted to the rotor and extending to the fuel pump.

10. The system of claim 1, further comprising a fuel inlet connected to one of the fuel metering unit and the at least one passage, and a fuel outlet connected to the other one of the fuel metering unit and the at least one passage.

11. A method for operating a brushless machine system for a gas turbine engine, the method comprising:
converting motive power into electrical power using an electric machine assembly having a permanent magnet rotor and a stator with stator windings;
pumping liquid fuel through a gas turbine engine fuel metering unit having a fuel pump; and
cooling the stator windings with the liquid fuel by flowing the liquid fuel through at least one passage extending between the machine assembly and the fuel metering unit, the at least one cooling passage having a portion in contact with the stator.

12. The method of claim 11, wherein flowing the liquid fuel through at least one passage comprises flowing the liquid fuel through the stator.

13. The method of claim 11, wherein flowing the liquid fuel through at least one passage comprises flowing the liquid fuel from a fuel inlet towards the stator and then sending the liquid fuel to the fuel metering unit.

14. The method of claim 11, wherein flowing the liquid fuel through at least one passage comprises flowing the liquid fuel from the fuel metering unit towards the stator.

15. The method of claim 14, further comprising returning the liquid fuel to the fuel metering unit in the at least one passage after having cooled the stator windings.

16. The method of claim 14, further comprising outputting the liquid fuel at a fuel outlet from the at least one passage.

17. The method of claim 11, wherein flowing the liquid fuel through at least one passage comprises flowing the liquid fuel through a first passage to cool a first set of the stator windings and flowing the liquid fuel through a second passage to cool a second set of the stator windings.

18. The method of claim 17, wherein the liquid fuel is flowed sequentially from the first passage to the second passage via passage inlets and outlets.

19. The method of claim 11, wherein the electric machine assembly is a starter-generator.

20. The method of claim 11, further comprising powering the fuel pump with a shaft from the electric machine assembly.
